(19) United States
(12) Patent Application Publication
(10) Pub. No.: US 2018/0135742 A1
(43) Pub. Date: May 17, 2018

(54) Ball Variator Continuously Variable Transmission

(71) Applicant: Dana Limited,, Maumee, OH (US)

(72) Inventor: Premsainath Selvarasu, Cedar Park, TX (US)

(21) Appl. No.: 15/857,899

(22) Filed: Dec. 29, 2017

Related U.S. Application Data
(60) Provisional application No. 62/587,578, filed on Nov. 17, 2017.

(51) Int. Cl. F16H 59/02; F16H 59/06; F16H 59/70; F16H 15/50

(52) U.S. Cl. CPC F16H 59/0208; F16H 59/06; F16H 2059/0269; F16H 15/503; F16H 2059/704; F16H 59/70

(57) ABSTRACT

Provided herein is a variator including: a first traction ring assembly in contact with a plurality of balls, wherein each ball of the plurality of balls has a tillable axis of rotation; a second traction ring assembly in contact with a plurality of balls; and an idler assembly located radially inward of the first traction ring assembly and the second traction ring assembly, the idler assembly in contact with the plurality of balls. The idler assembly includes a first idler ring, a second idler ring, an inner idler race located radially inward of the first idler ring and the second idler ring, a plurality of bearing balls operably coupled to the second idler ring and the inner idler race, and a first visco-elastic damper member coupled to the first idler ring and the inner idler race.

### RELATED APPLICATION

This application claims the benefit of U.S. Provisional Patent Application No. 62/587,578, filed Nov. 17, 2017, which is incorporated herein by reference in its entirety.

### BACKGROUND

A driveline including a continuously variable transmission allows an operator or a control system to vary a drive ratio in a stepless manner, permitting a power source to operate at its most advantageous rotational speed. During operation, high frequency vibration is transmitted to components of the transmission and, in some cases, result in load fluctuations at contacting components, which impacts the durability and operating life span of the transmission. Therefore, it is desirable to mitigate vibration on internal components of the transmission.

### SUMMARY

Provided herein is a variator including: a first traction ring assembly in contact with a plurality of balls, wherein each ball of the plurality of balls has a tiltable axis of rotation; a second traction ring assembly in contact with a plurality of balls; and an idler assembly located radially inward of the first traction ring assembly and the second traction ring assembly, the idler assembly in contact with the plurality of balls. The idler assembly includes a first idler ring, a second idler ring, an inner idler race located radially inward of the first idler ring and the second idler ring, a plurality of bearing balls operably coupled to the second idler ring and the inner idler race, and a first visco-elastic damper member coupled to the first idler ring and the inner idler race.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

Novel features of the preferred embodiments are set forth with particularity in the appended claims. A better understanding of the features and advantages of the present embodiments will be obtained by reference to the following detailed description that sets forth illustrative embodiments, in which the principles of the preferred embodiments are utilized, and the accompanying drawings of which:

FIG. 1 is a side sectional view of a ball-type variator.

FIG. 2 is a plan view of a carrier member that is used in the variator of FIG. 1.

FIG. 3 is an illustrative view of different tilt positions of the ball-type variator of FIG. 1.

FIG. 4 is a schematic view of the idler assembly of the variator of FIG. 1.

FIG. 5 is a schematic view of an idler assembly provided with damping members.

FIG. 6 is a schematic view of another idler assembly provided with damping members.

### DETAILED DESCRIPTION OF THE PREFERRED EMBODIMENTS

The preferred embodiments will now be described with reference to the accompanying figures, wherein like numerals refer to like elements throughout. The terminology used in the descriptions below is not to be interpreted in any limited or restrictive manner simply because it is used in conjunction with detailed descriptions of certain specific embodiments. Furthermore, the preferred embodiments includes several novel features, no single one of which is solely responsible for its desirable attributes or which is essential to practicing the embodiments described.

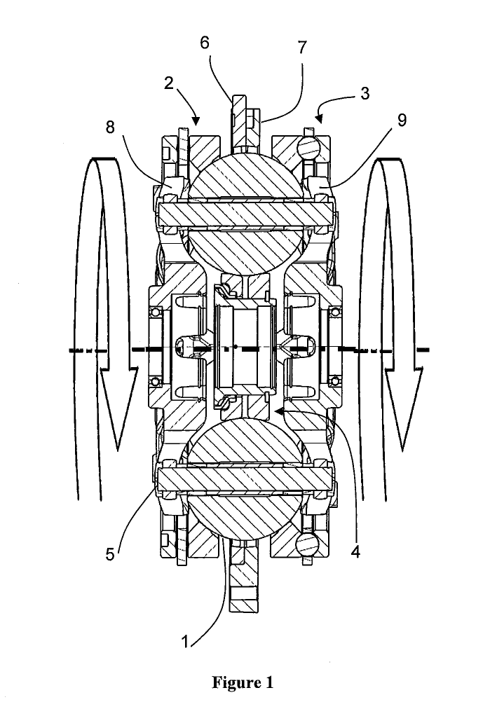

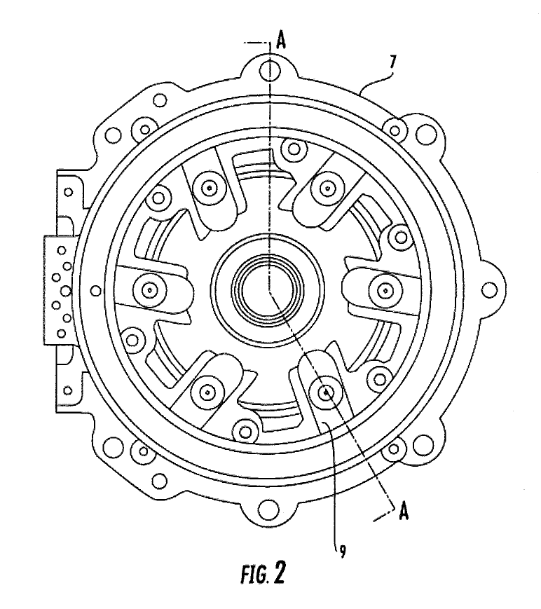

Provided herein are configurations of continuously variable transmissions (CVTs) based on a ball type variators, also known as CVP, for continuously variable planetary. Basic concepts of a ball type Continuously Variable Transmissions are described in U.S. Pat. Nos. 8,469,856 and 8,870,711 incorporated herein by reference in their entirety. Such a CVT, adapted herein as described throughout this specification, includes a number of balls (planets, spheres) 1, depending on the application, two ring (disc) assemblies with a conical surface in contact with the balls, an input (first) traction ring 2, an output (second) traction ring 3, and an idler (sun) assembly 4 as shown on FIG. 1. The balls are mounted on tiltable axles 5, themselves held in a carrier (stator, cage) assembly having a first carrier member 6 operably coupled to a second carrier member 7. The first carrier member 6 rotates with respect to the second carrier member 7, and vice versa. In some embodiments, the first carrier member 6 is fixed from rotation while the second carrier member 7 is configured to rotate with respect to the first carrier member, and vice versa. In one embodiment, the first carrier member 6 is provided with a number of radial guide slots 8. The second carrier member 7 is provided with a number of radially offset guide slots 9, as illustrated in FIG. 2. The radial guide slots 8 and the radially offset guide slots 9 are adapted to guide the tiltable axles 5. The axles 5 are adjusted to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, but are slightly different.

The working principle of such a CVP of FIG. 1 is shown on FIG. 3. The CVP itself works with a traction fluid. The lubricant between the ball and the conical rings acts as a solid at high pressure, transferring the power from the input ring, through the balls, to the output ring. By tilting the balls' axes, the ratio is changed between input and output. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler. Embodiments disclosed here are related to the control of a variator and/or a CVT using generally spherical planets each having a tillable axis of rotation that are adjusted to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In one embodiment, a control system coordinates the use of a skew angle to generate forces between certain contacting components in the variator that will tilt the planet axis of rotation. The tilting of the planet axis of rotation adjusts the speed ratio of the variator.

For description purposes, the term “radial” is used here to indicate a direction or position that is perpendicular relative to a longitudinal axis of a transmission or variator. The term “axial” as used here refers to a direction or position along an axis that is parallel to a main or longitudinal axis of a transmission or variator. For clarity and conciseness, at times similar components labeled similarly (for example, bearing 1011A and bearing 1011B) will be referred to collectively by a single label (for example, bearing 1011).

As used here, the terms “operationally connected,” “operationally coupled”, “operationally linked”, “operably connected”, “operably coupled”, “operably linked,” “operably coupleable” and like terms, refer to a relationship (mechanical, linkage, coupling, etc.) between elements whereby operation of one element results in a corresponding, following, or simultaneous operation or actuation of a second element. It is noted that in using said terms to describe the embodiments, specific structures or mechanisms that link or couple the elements are typically described. However, unless otherwise specifically stated, when one of said terms is used, the term indicates that the actual linkage or coupling take a variety of forms, which in certain instances will be readily apparent to a person of ordinary skill in the relevant technology.

It should be noted that reference herein to “traction” does not exclude applications where the dominant or exclusive mode of power transfer is through “friction.” Without attempting to establish a categorical difference between traction and friction drives here, generally these are typically understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction force which would be available at the interfaces of the contacting components and is the ratio of the maximum available drive torque per contact force. Typically, friction drives generally relate to transferring power between two elements by frictional forces between the elements. For the purposes of this disclosure, it should be understood that the CVTs described here operate in both tractive and frictional applications. For example, in the embodiment where a CVT is used for a bicycle application, the CVT operates at times as a friction drive and at other times as a traction drive, depending on the torque and speed conditions present during operation.

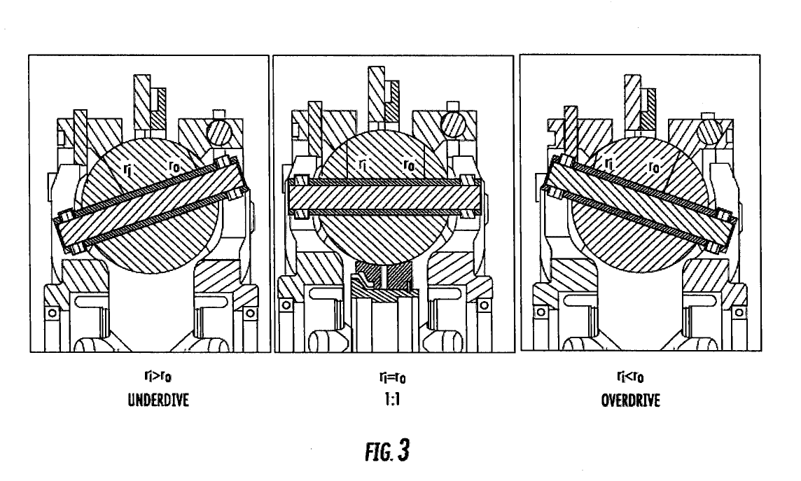

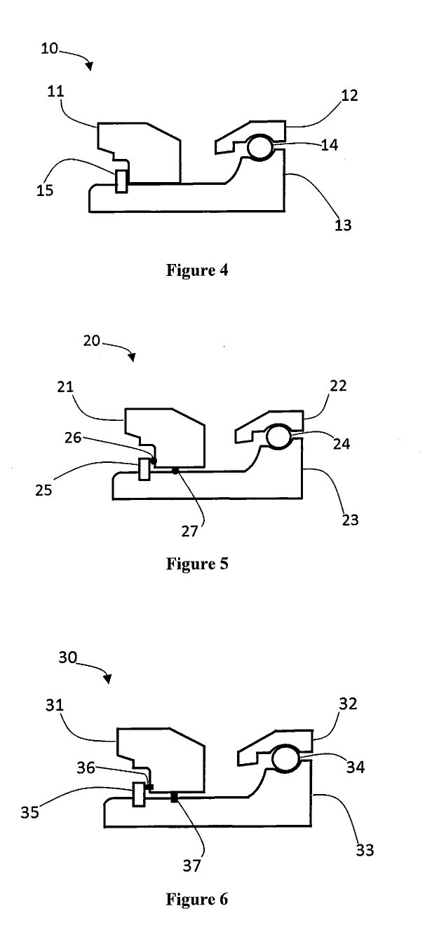

Referring now to FIG. 4, in some embodiments, an idler assembly 10 is optionally configured to be used in the variator depicted in FIGS. 1-3. In some embodiments, the idler assembly 10 includes a first idler ring 11 and a second idler ring 12, each in contact with the balls 1. The second idler ring 12 is operably coupled to an inner idler race 13 through a number of bearing balls 14. The inner idler race 13 is configured to couple to the first idler ring 11. A circlip 15 is adapted to retain the first idler ring 11 axially to the inner idler race 13.

Turning now to FIG. 5, in some embodiments, an idler assembly 20 is optionally configured to be used in the variator depicted in FIGS. 1-3. In some embodiments, the idler assembly 20 includes a first idler ring 21 and a second idler ring 22, each in contact with the balls 1. The second idler ring 22 is operably coupled to an inner idler race 23 through a number of bearing balls 24. The inner idler race 23 is configured to couple to the first idler ring 21. A circlip 25 is adapted to retain the first idler ring 21 axially to the inner idler race 23. In some embodiments, a first visco-elastic damper member 26 is positioned between the first idler ring 21 and the circlip 25. The visco-elastic damper member 26 is optionally an o-ring or similar component. In some embodiments, a second visco-elastic member 27 is optionally provided. The second visco-elastic member 27 is positioned between the inner idler race 23 and the first idler ring 21. The second visco-elastic member is optionally an o-ring or similar component.

Referring now to FIG. 5, in some embodiments, an idler assembly 30 is optionally configured to be used in the variator depicted in FIGS. 1-3. In some embodiments, the idler assembly 30 includes a first idler ring 31 and a second idler ring 32, each in contact with the balls 1. The second idler ring 32 is operably coupled to an inner idler race 33 through a number of bearing balls 34. The inner idler race 33 is configured to couple to the first idler ring 31. A circlip 35 is adapted to retain the first idler ring 31 axially to the inner idler race 33. In some embodiments, a first visco-elastic damper member 36 is positioned between the first idler ring 31 and the circlip 35. The visco-elastic damper member 36 is optionally a square profile o-ring or gasket. In some embodiments, a second visco-elastic member 37 is optionally provided. The second visco-elastic member 37 is positioned between the inner idler race 33 and the first idler ring 31. The second visco-elastic member is optionally a square profile o-ring or similar component.

While preferred embodiments have been shown and described herein, it will be obvious to those skilled in the art that such embodiments are provided by way of example only. Numerous variations, changes, and substitutions will now occur to those skilled in the art without departing from the preferred embodiments. It should be understood that various alternatives to the embodiments described herein may be employed in practice. It is intended that the following claims define the scope of the preferred embodiments and that methods and structures within the scope of these claims and their equivalents be covered thereby.

What is claimed is:

1. A variator comprising:
a first traction ring assembly in contact with a plurality of balls, wherein each ball of the plurality of balls has a tiltable axis of rotation;
a second traction ring assembly in contact with a plurality of balls; and
an idler assembly located radially inward of the first traction ring assembly and the second traction ring assembly, the idler assembly in contact with the plurality of balls, the idler assembly comprising:
a first idler ring;
a second idler ring;
an inner idler race located radially inward of the first idler ring and the second idler ring;
a plurality of bearing balls operably coupled to the second idler ring and the inner idler race; and
a first visco-elastic damper member coupled to the first idler ring and the inner idler race.

2. The variator of claim 1, further comprising a circlip coupled to the inner idler race and operably coupled to the first idler ring.

3. The variator of claim 2, wherein the first visco-elastic damper member is positioned between the first idler ring and the circlip.

4. The variator of claim 1, wherein the first visco-elastic damper is an o-ring.

5. The variator of claim 1, wherein the first visco-elastic damper is a square profile o-ring.

6. The variator of claim 1, wherein the second visco-elastic damper is an o-ring.

7. The variator of claim 1, wherein the second visco-elastic damper is a square profile o-ring.
